(19) United States
(12) Patent Application Publication
(10) Pub. No.: US 2012/0324847 A1
(43) Pub. Date: Dec. 27, 2012

(54) SUPPORT BRACKET ASSEMBLY AND INTERLOCKING CERAMIC TILE SYSTEM

(75) Inventors: James Jacob Dupree, Draper, UT (US); Thomas A. Diemert, Maysville, KY (US)

(73) Assignee: J.T. THORPE & SON, INC., Richmond, CA (US)

(21) Appl. No.: 13/166,776

(22) Filed: Jun. 22, 2011

(51) Int. Cl. B01D 45/16; B23K 31/02; F16M 13/00

(52) U.S. Cl. 55/458; 248/309.1; 228/101

(57) ABSTRACT

The present disclosure relates to a support bracket assembly and multiple support bracket assemblies supporting a series of interlocking ceramic elements. The interlocking ceramic elements form a cylindrical structure that is an important component of a cyclone separator. Several industrial plants have large cyclone separators such as power plants and cement plants where it is necessary to remove solids from a particle-laden gas stream. The support bracket assembly is comprised of five main components: two end plates, a middle support arm which is capable of supporting a ceramic element, and two horizontal flat bars that fit through the two end plates and the middle support arm.

### TECHNICAL FIELD

The present disclosure relates to a support bracket assembly, specifically a support bracket assembly used to support an interlocking ceramic tile system within a vortex finder of a cyclone separator.

### BACKGROUND

A vortex finder is a cylindrical structure (also known as center pipe, dip tube, immersion tube, thimble, gas tube) inside a cyclone separator where this cylinder provides improved particle separation from a particle-laden gas stream.

A key part of electrical generating power plants and cement manufacturing plants is the cyclone separator. The purpose of the cyclone separator is to separate particulates from a particle-laden gas stream. The cyclone separator is typically arranged as a vertical cylinder with a conical section at the bottom and a cylindrical outlet duct at the top. The cyclone inlet stream consists of a mixture of flowing gases and solids.

Cleaner gas exits the top of the cylinder, while particulates exit through the bottom of the conical portion. The incoming gas-particle mixture enters near the top of the cylindrical portion where the gas-particle mixture is forced to rotate around the axis of the cylinder. When the velocity of the gas-particle mixture reaches sufficient flow conditions, the rotating flow causes centrifugal forces to spin the heavier particles outward and along the inside walls of the cyclone separator. These heavier particles will eventually flow downward due to gravitational forces towards the lower cone. The spinning gases and a portion of the lighter particles will remain closer to the central axis of the cyclone separator and flow upwards through the vortex finder and out the exit tube. The lower conical section of the cyclone collects the heavier particles where these heavier particles exit through the bottom outlet nozzle.

The tube at the top of the cyclone separator is more commonly known as a vortex finder. Typically the vortex finder tube extends below the cyclone roof. The diameter and length of the vortex finder is sized to provide optimum pressure drop and particle separation efficiency of the cyclone separator system.

It is common for a vortex finder in a power plant or cement plant to be fabricated using either metal or ceramic tiles. Since a typical power plant and cement plant vortex finder is exposed to extreme temperatures, e.g., operating temperatures of approximately 1700° F. (927° C.), a common problem with a metallic vortex finder is to find the metallic parts excessively warped and distorted after only about one year in operation. A metallic vortex finder must be fabricated using expensive alloys that must withstand both high temperature and high velocity of erosive particles that flow through the cyclone. Repairs to a steel vortex finder require either replacement of the damaged parts or specialized heat-treating and welding procedures. In both repair scenarios, replacement or steel repairs can result in excessive maintenance costs and loss of operational profit.

In a power plant or cement manufacturing plant, the pressure-containing shell of a cyclone separator is typically made of steel, such as carbon steel. The dimensions of a cyclone separator are dependent on the plant's designed operating conditions. As one example, the vertical height of a cyclone separator may be 62 feet (18.9 meters) from the bottom of the cone to the top of the vortex finder and 28 feet 10 inches (8.8 meters) outside diameter. For this cyclone separator, the vertical height of the vortex finder will typically measure approximately 8 feet (2.4 meters) with an inside diameter of 13 feet 9 inches (4.2 meters). The normal internal operating temperature within the cyclone can be approximately 1700° F. (927° C.).

Because of the internal operating temperature, the cyclone separator pressure-containing steel shell may be insulated with internal insulating materials such as bricks, refractory concretes, ceramic insulating blankets, shaped ceramics, or combinations thereof. These internal lining materials are selected to maintain their functional ability at the operating temperature while being exposed to corrosive gases, anticipated mechanical loads and the erosive action of high velocity solids traveling along the exposed surfaces.

An alternative to a metallic vortex finder, a vortex finder may also be constructed of a series of interlocking pre-cast ceramic tiles, shapes, or elements that are combined to form a cylindrical structure. Vortex finder ceramic material must handle the anticipated mechanical loads, maintain functional ability at the operating temperature while being exposed to corrosive gases and the erosive action of high velocity solids traveling along the exposed surfaces.

Interlocking ceramic tiles are known in the art, e.g., pre-cast and pre-fired ceramic interlocking dog-bone shapes. Specifically, interlocking tiles manufactured by M.H. Detrick Co., described in U.S. Pat. No. 4,977,838 as a square wall may be modified into a cylindrical system of interlocking ceramic tiles. Also, The A.J. Weller Corporation offers WellerHASLE® interlocking ceramic elements.

Attaching the series of interlocking ceramic elements to the inner wall of the cyclone separator outlet duct has presented a number of challenges. Installation of the ceramic elements requires skilled craftsmen to level the tiles and set each tile at the spacing required to form a uniform cylindrical shape of the completed assembly. A system for supporting the weight of the interlocking ceramic elements and for allowing for easy installation of the interlocking ceramics will result in improved dimensional controls and labor cost savings.

One prior art system of supporting the interlocking ceramic elements involves a steel ring with metallic arms welded to the inside diameter of this ring. The outside diameter of the steel ring has metal horizontal braces that are welded to the steel ring and to the inner wall of the cyclone separator outlet duct. The steel ring, metallic support arms and connecting arms are fabricated using high temperature stainless steel alloy. The steel ring support system is more difficult to install than the present invention because: (1) the metallic support arms must be carefully placed and welded to the steel ring which makes small adjustments time consuming and labor intensive and (2) it is not possible for the steel ring to be fabricated in a perfect circle which can result in dimensional problems and out of roundness of the final ceramic tile assembly.

Therefore, it is desirable to provide a support bracket assembly system that supports the interlocking ceramic elements while allowing for an easy installation of the elements. The present invention provides for such a support bracket assembly system, which supports the weight of the tiles during construction, provides a simple means to level the tiles while allowing for horizontal adjustment between the elements.

### SUMMARY

One embodiment of the present invention is a support bracket assembly comprising two end plates, a support arm plate, and two horizontal flat bars. The support arm plate is located in between the two end plates in a horizontal direction and comprises three sections: two top sections and one bottom section, wherein a first of the two top sections extend longer than the two end plates in a radial direction. The two horizontal flat bars extend through the two end plates in the horizontal direction, wherein a first horizontal flat bar is located below the first top section of the support arm, and wherein a second horizontal flat bar is located in between a second top section of the support arm and above the bottom section of the support arm plate.

There may be a gap in the radial direction in between the support arm plate and the first of the two horizontal flat bars. There may be gap in the radial direction in between the support arm plate and the second of the two horizontal flat bars. The end plates may comprise a rectangular slot shaped to receive the first horizontal flat bar. The end plates may comprise a rectangular hole shaped to receive the second horizontal flat bar. The end plates, support arm, and flat bars may be made of stainless steel alloy. The support bracket assembly may weigh approximately 40 pounds (18.1 Kilograms).

In one embodiment, support arm plate is about 1.5 inches (38 millimeters) thickness. The first top section of the support arm plate may have a rounded tip to receive a ceramic vortex finder element. The support arm plate is located substantially in the middle of the two end plates in the horizontal direction and is anvil-shaped. The support arm plate extends about 4 inches (102 millimeters) longer that the end plates in the radial direction.

The support bracket assembly may be used to support a ceramic vortex finder element. Thus, another embodiment of the invention is a support bracket assembly and ceramic vortex finder element. Further, another embodiment of the invention is a plurality of support bracket assemblies, wherein each support bracket assembly supports a ceramic vortex finder element.

Another embodiment of the invention is a series of interlocking ceramic elements, wherein the interlocking ceramic elements form a vortex finder, wherein the series of interlocking ceramic elements comprises a plurality of support bracket assemblies and a plurality of interlocking ceramic elements, wherein at least one ceramic element is supported by the support arm plate of the at least one support bracket assembly. Another embodiment of the present invention is a vortex finder comprising a series of interlocking ceramic elements and a plurality of support bracket assemblies.

Another embodiment of the invention is a method of installing a series of interlocking ceramic elements to an inside wall of a cyclone separator outlet duct. The method comprises the steps of: (1) prefabricating a plurality of support bracket assemblies; (2) welding the end plates of each support bracket assembly to the inside wall of the cyclone separator outlet duct; (3) placing a ceramic element on each support arm plate of each support bracket assembly; (4) interconnecting a first row of interlocking ceramic elements, wherein a plurality of elements of the first row of interlocking elements is supported by a support bracket assembly; (5) welding the support arm plate of each support bracket assembly to the horizontal flat bars of each support bracket assembly once the first row of elements is in place; (6) interconnecting a second row of interlocking ceramic elements, wherein the second row of elements is supported by the first row of elements; and (7) interconnecting a plurality of rows of interlocking ceramic elements, wherein each row of elements is supported by a preceding row of elements.

There have thus been outlined the more important features of the invention in order that the detailed description that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for designing other structures, methods, and systems for carrying out the several purposes of the present invention. It is important, therefore, that the claims be regarded as including such equivalent constructions insofar as they do not depart from the spirit and scope of the present invention.

All dimensions are stated in U.S. customary units unless specifically noted otherwise.

### BRIEF DESCRIPTION OF THE DRAWINGS

The accompanying drawings, which are incorporated in and form a part of the specification, illustrate various embodiments and, together with the description, serve to explain the principles the various embodiments.

FIG. 1 is a side view of an end plate, which forms part of a support bracket assembly.

FIG. 2 is a side view of a support arm plate, which forms part of a support bracket assembly.

FIG. 3 is side view of a support bracket assembly attached to the inside wall of a cyclone separator outlet duct.

FIG. 4 is a top view of a support bracket assembly attached to the inside wall of a cyclone separator outlet duct.

FIG. 5 is a top view of a plurality of support bracket assemblies attached to the inside wall of a cyclone separator outlet duct.

FIG. 6 is a perspective view of a series of interlocking ceramic elements being supported by a plurality of support bracket assemblies forming a vortex finder.

### DETAILED DESCRIPTION

Some power and cement plants currently have a cyclone separator with a vortex finder constructed of a series of interlocking ceramic tiles. While the present example describes a vortex finder in a power plant cyclone separator, other cyclone separator units may also function using an interlocking ceramic tile system and the support bracket system described herein. The present invention may also be used in the power, cement, or petro-chemical industries.

The support bracket assembly may be described as a fixed cantilever support bracket. The support bracket assembly is comprised of five main pieces: two end plates, one support arm located in between the two end plates, and two horizontal flat bars extending through the two end plates. The support bracket assembly is fixed to the inside wall of the cyclone separator outlet duct at the two end plates. The support bracket assembly extends from the wall in a radial direction. The support bracket assembly has a height (vertical direction) and a width (horizontal direction). The horizontal flat bars lie in the horizontal direction. The support arm bears the load of the interlocking ceramic elements. The support arm is located substantially in the middle of the two end plates.

FIG. 1 shows the side view of one of the identical end plates 1. The end plate is four-sided, with side 2 to be attached to the inside wall of the vortex finder. For example, the height of the end plate is about 8 inches (203 millimeters) vertical direction), the length about 9 inches (229 millimeters) in the radial direction, and the thickness of about 0.5 inches (13 mm) in the horizontal direction. The end plate 1 has two rectangular slots 3 and 4 through which to place the two horizontal flat bars. The rectangular hole 3 is a four-sided hole through the end plate 1. Rectangular slot 4 is cut into the end plate 1. Both rectangular slots 3 and 4 of the end plate 1 may be approximately 2.75 inches (70 millimeters) in length and 0.75 inches (19 millimeters) in height. In one embodiment, each of the two end plates 1 weighs approximately 7.9 pounds (3.6 kilograms).

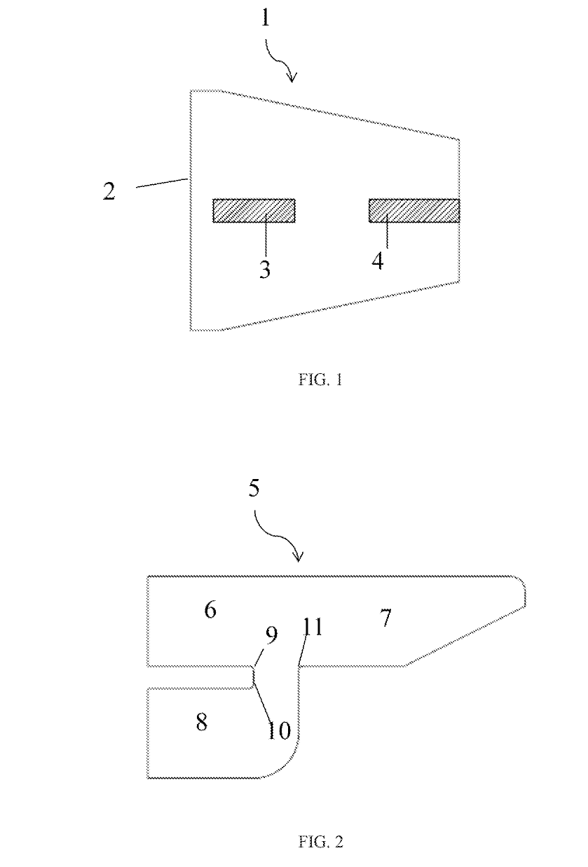

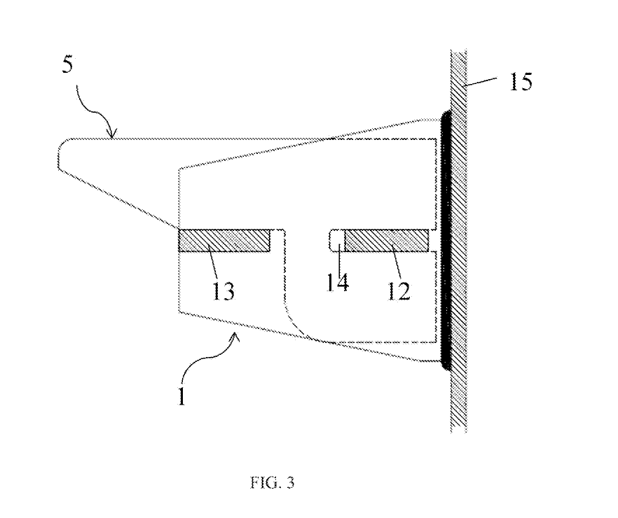

FIG. 2 demonstrates the side view of the support arm 5, which has an asymmetrical anvil-shape. The support arm 5 may be about 6.75 inches (171 millimeters) in height (vertical direction), about 12.5 inches (318 millimeters) in width (radial direction), and about 1.5 inches (38 millimeters) thick (horizontal direction). The support arm has three sections: section 6 and 7 on top, and section 8 on bottom (vertical direction). In between sections 6 and 8 there is a 0.75 inch (19 millimeters) gap (vertical direction). Section 7 is about 4 inches (102 millimeters) longer in width (radial direction) than the end plate 1. The tip of section 7 is what attaches to the ceramic element. The tip of section 7 has a radius of about 0.5 inches (13 millimeters). There is a dimple or hole in the ceramic element which receives the tip of section 7 of support arm 5. The tip of section 7 is rounded because the internal shape of the mating ceramic element is rounded. If the tip of section 7 had a sharp edge, the sharp edge of the metallic support arm may cause the ceramic tile to crack when operating loads are applied. The first of the horizontal flat bars fit between sections 6 and 8 (vertical direction). The second horizontal flat bar sits below section 7 of support arm 5 (vertical direction). Sections 6, 7, and 8 are all approximately 3 inches (76 millimeters) in height (vertical direction). The radii at 9, 10, and 11 are approximately 0.125 inches (3 millimeters). The radius in the bottom section 8 is about 0.5 inches (13 millimeters). In one embodiment, the support arm 5 may weigh approximately 15 pounds (6.8 kilograms).

FIG. 3 demonstrates a side view of the support bracket assembly including end plate 1, support arm 5, and horizontal flat bars 12 and 13. The flat bars 12 and 13 have the same thickness, approximately 0.75 inch (19 millimeters) (vertical direction), but are not the same size. Flat bar 12 is 2.75 inches (70 millimeters) in width (radial direction), while flat bar 13 is 3 inches (76 millimeters) in width (radial direction). Each flat bar 12 and 13 are approximately 7.25 inches (184 millimeters) in length (horizontal direction). Flat bar 12 weighs approximately 4.3 pounds (2 kilograms), while flat bar 13 weighs 4.69 pounds (2.1 kilograms). There is a 0.5 inch (13 millimeters) gap 14 between the horizontal bar 12 and end plate 1 and support arm 5. The end plate 1 attaches to the inside wall of the cyclone separator outlet duct 15. The gap 14 in between the horizontal bar 12 and the support arm 5 allows for radial adjustment of the ceramic elements during installation. Specifically, this gap 14 allows for the diameter of the cylinder of interlocking ceramic elements to be adjusted during the installation of the individual elements. This adjustment is necessary because it is unlikely that the cyclone separator outlet duct and the circular interlocking ceramic element system will be a perfect circle.

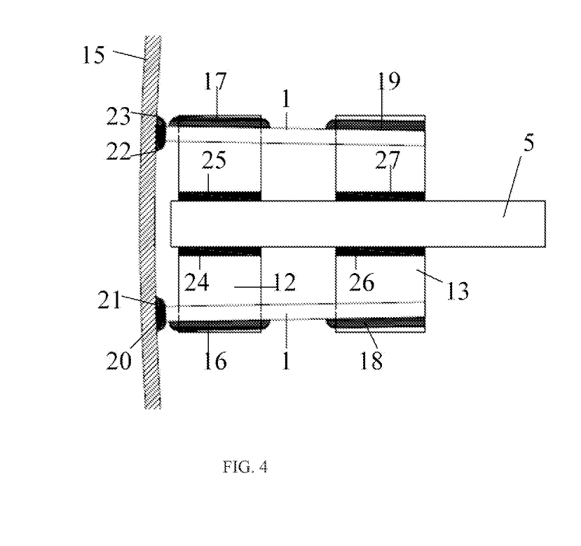

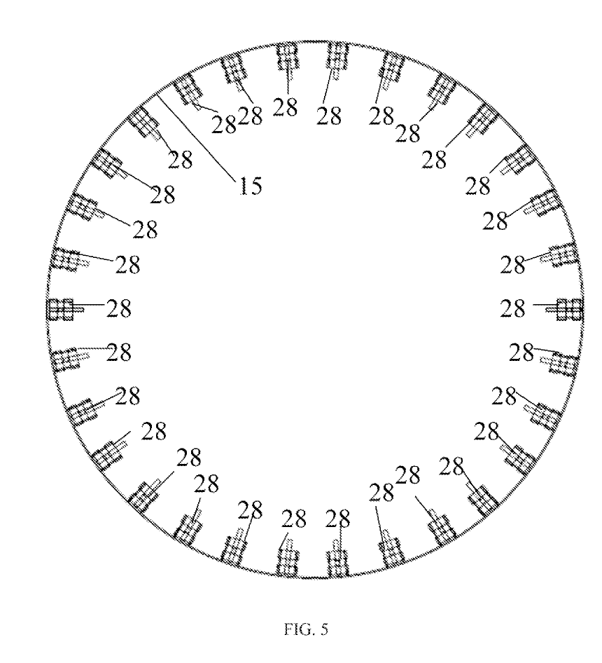

FIG. 4 demonstrates a top view of the support bracket assembly including end plates 1, support arm 5, and horizontal flat bars 12 and 13. Before installation of the support bracket assemblies, the two flat bars 12 and 13 are welded to the end plates 1. This welded pre-assembly (two flat bars 12 and 13 welded to the end plates 1) may be completed in a fabrication shop. See welds at 16, 17, 18, and 19. Installation of the support bracket assemblies includes welding the end plates 1 to the inside wall of the cyclone separator outlet duct 15 at welds 20, 21, 22 and 23. After all support bracket assemblies are installed, craftsmen will install the top row of interlocking ceramic vortex finder elements. While installing the top row of elements, the support arms 5 can be adjusted. The support arm 5 may move horizontally, along the direction of the horizontal flat bars 12 and 13, during installation of the interlocking ceramic elements, allowing for easier installation of the intricate puzzle of interlocking pieces. After all support arm adjustments are completed, the support arm 5 may be fillet welded to the horizontal flat bars 12 and 13 at welds 24, 25, 26 and 27. The fillet welds at 24, 25, 26, and 27 are only necessary to fix the location of the support arms, but these welds do not support any weight of the interlocking ceramic elements. All welds 16-19 and 24-27 are specifically located away from the high stress and high temperature area of the vortex finder.

The support bracket assembly may be made of a suitable chromium-nickel austenitic stainless steel alloy that can handle the operating loads while being exposed to the operating temperature and corrosive gases. There are several suitable alloys that may be used, such as alloys included in the American Iron and Steel Institute 300 series (AISI 300) stainless steels. The combination of the two end plates, the support arm, and the two flat bars, in one embodiment, will weigh a total of approximately 40 pounds (18.1 kilograms).

The interlocking ceramic elements may be pre-cast and pre-fired ceramic tiles or other suitable material, such as a refractory concrete. The ceramic elements form a cylindrical wall along the inner wall of the outlet duct of the cyclone separator. This cylindrical wall of interlocking elements may be approximately 16 feet (4.9 meters) in diameter and approximately 10 feet (3 meters) in height. A plurality of the first layer of ceramic elements is supported by a plurality of support bracket assemblies. Each row of dog-bone shaped ceramic elements provides support for the adjacent lower row of elements. This configuration results in lower rows of interlocking ceramic elements that are hanging from the top row of ceramic elements.

FIG. 5 demonstrates a top view of one embodiment of the invention, wherein thirty support bracket assemblies 28 attach to the inside wall of the cyclone separator outlet duct 15. In this embodiment, the steel shell inside diameter of the cyclone separator outlet duct is approximately 16 feet (4.9 meters). Each of the 30 support bracket assemblies supports a corresponding ceramic element in the first row of the interlocking cylindrical wall. For these example dimensions and number of elements, this results in a rate of one support bracket assembly per 1.7 feet (one support bracket assembly per 518 millimeters) measured along the circumference. The top row of ceramic tiles includes special ceramic elements that are intended to be supported by the steel support arm of the bracket assembly. These special ceramic elements, or “support lugs” each are constructed with a special indentation or dimple in them so as to receive the tip of the steel support arm.

In the first row of interlocking ceramic elements, every other element is a “support lug”, which is molded in the shape of a half element so as to create the interlocking row of elements. The support lug is similar to a single dog-bone shape ceramic element cut in half in the vertical direction. In the first row of interlocking ceramic elements, only the ceramic support lugs are eligible to be supported by the steel support arm of the support bracket assembly.

The next layer of ceramic elements is then fitted below the first layer. There is no need for half pieces (support lugs) after the first row. The ceramic elements are arranged in a plurality of layers or rows of interlocking ceramic elements shaped such that each lower layer of elements hangs from the adjacent upper layer of elements in an interlocking fashion. Some vortex finder assemblies may contain as many as 8 to 12 rows or layers of interlocking elements. During installation of the vortex finder tiles, each complete layer or row of elements are put into place, one after the other, starting from the top layer that contains the support lugs which are supported by the steel support bracket assemblies.

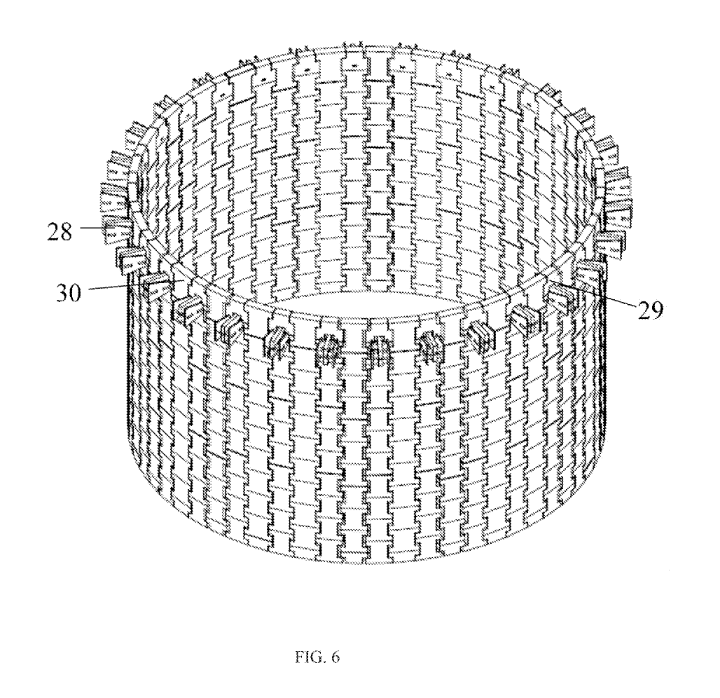

FIG. 6 is a perspective view of a series of interlocking ceramic elements being supported by a plurality of support bracket assemblies forming a vortex finder. Continuing with the current example, FIG. 6 demonstrates thirty support bracket assemblies 28 supporting thirty ceramic element half pieces (support lugs) 29. All the support lugs 29 of FIG. 6 are supported by the support bracket assemblies 28. In between each support lug 29 is a full ceramic element 30. There are ten rows of interlocking ceramic elements in FIG. 6. The cyclone separator unit is not shown in FIG. 6 so that the interlocking ceramic elements may be viewed unobstructed. However, as described, the support bracket assemblies 28 are to be welded to the inside of the inside wall of the cyclone separator outlet duct.

The ceramic elements may be constructed as dog bone or “I” shaped. The density of the ceramic element may be approximately 180 pounds per cubic foot (2.9 grams per cubic centimeter). The element may have a thickness (radial dimension) of approximately 3.25 inches (83 millimeters), an inner-chord length of approximately of approximately 7.75 inches (197 millimeters), an outer-chord length of approximately 11.75 inches (298 millimeters), a height of approximately 13.25 inches (337 millimeters). The weight of a ceramic element can be approximately 39 pounds (17.7 kilograms). Therefore, a support lug (half element) weighs approximately 20 pounds (9 kilograms). The ceramic elements are pre-cast and heat treated before use. The selected ceramic element material and heat treatment must provide an element that can handle the operating loads, operating temperatures and corrosive environment.

Continuing the example wherein thirty support bracket assemblies are used in a cyclone separator outlet duct that has a diameter of approximately 16 feet (4.9 meters), there may be approximately 572 interlocking ceramic elements. The total of all 572 elements can weigh approximately 21,000 pounds (9,525 kilograms). The static load on each steel support bracket will be 1/30^{th} of the total load or approximately 700 pounds (317.5 kilograms).

The support bracket assemblies have been described for use in a vortex finder of a cyclone separator. Modifications and alterations will occur to other cyclone separator systems upon reading and understanding the preceding detailed description. It is intended that the exemplary embodiments be construed as including all such modifications and alterations insofar as they come within the scope of the appended claims or the equivalents thereof.

While the invention herein disclosed has been described by means of specific embodiments and applications thereof, numerous modifications and variations could be made thereto by those skilled in the art without departing from the scope of the invention set forth in the claims.

What is claimed is:

1. A support bracket assembly comprising:
two end plates;
a support arm plate located in between the two end plates in a horizontal direction comprising three sections, wherein the three sections are two top sections and one bottom section, wherein a first of the two top sections extends longer than the two end plates in a radial direction and is capable of supporting a ceramic element; and
two horizontal flat bars extending through the two end plates in the horizontal direction, wherein a first horizontal flat bar is located below the first top section of the support arm, and wherein a second horizontal flat bar is located in between a second top section of the support arm and above the bottom section of the support arm plate.

2. The support bracket assembly of claim 1, wherein the first top section of the support arm plate has a rounded tip to receive a ceramic element.

3. The support bracket assembly of claim 1, wherein there is a gap in the radial direction in between the support arm plate and the first of the two horizontal flat bars.

4. The support bracket assembly of claim 1, wherein there is a gap in the radial direction in between the support arm plate and the second of the two horizontal flat bars.

5. The support bracket assembly of claim 1, wherein the end plates comprise a rectangular slot shaped to receive the first horizontal flat bar.

6. The support bracket assembly of claim 1, wherein the end plates comprise a rectangular hole shaped to receive the second horizontal flat bar.

7. The support bracket assembly of claim 1, wherein the support arm plate is about 1.5 inches thick.

8. The support bracket assembly of claim 1, wherein the end plates, support arm, and flat bars are made of stainless steel alloy.

9. The support bracket assembly of claim 1, wherein the support arm plate is located substantially in the middle of the two end plates in the horizontal direction.

10. The support bracket assembly of claim 1, wherein the support arm plate extends about 4 inches longer that the end plates in the radial direction.

11. The support bracket assembly of claim 1, wherein the support arm plate is anvil-shaped.

12. The support bracket assembly of claim 1, wherein the two horizontal flat bars are welded to the two end plates.

13. The support bracket assembly of claim 1, wherein the two horizontal flat bars are welded to the support arm plate.

14. The support bracket assembly of claim 1, wherein the support arm plate is capable of supporting a ceramic element weighing up to about 40 pounds.

15. A support bracket assembly and ceramic element system comprising:
a support bracket assembly comprising: two end plates,
a support arm plate located in between the two end plates in a horizontal direction comprising three sections, wherein the three sections are two top sections and one bottom section, wherein a first of the two top sections extends longer than the two end plates in a radial direction and is capable of supporting a ceramic element, and two horizontal flat bars extending through the two end plates in the horizontal direction, wherein a first horizontal flat bar is located below the first top section of the support arm, and wherein a second horizontal flat bar is located in between a second top section of the support arm and above the bottom section of the support arm plate; and
a ceramic element supported by the support arm plate.

16. A series of interlocking ceramic elements comprising:
a plurality of support bracket assemblies, wherein at least one support bracket assembly comprises: two end plates,
a support arm plate located in between the two end plates in a horizontal direction comprising three sections, wherein the three sections are two top sections and one bottom section, wherein a first of the two top sections extends longer than the two end plates in a radial direction and is capable of supporting a ceramic element, and
two horizontal flat bars extending through the two end plates in the horizontal direction, wherein a first horizontal flat bar is located below the first top section of the support arm, and wherein a second horizontal flat bar is located in between a second top section of the support arm and above the bottom section of the support arm plate; and
a plurality of interlocking ceramic elements, wherein at least one ceramic element is supported by the support arm plate of the at least one support bracket assembly.

17. A cylindrical vortex finder inside of a cyclone separator comprising:
a plurality of support bracket assemblies, wherein at least one support bracket assembly comprises: two end plates,
a support arm plate located in between the two end plates in a horizontal direction comprising three sections, wherein the three sections are two top sections and one bottom section, wherein a first of the two top sections extends longer than the two end plates in a radial direction and is capable of supporting a ceramic element, and
two horizontal flat bars extending through the two end plates in the horizontal direction, wherein a first horizontal flat bar is located below the first top section of the support arm, and wherein a second horizontal flat bar is located in between a second top section of the support arm and above the bottom section of the support arm plate; and
a plurality of interlocking ceramic elements, wherein at least one ceramic element is supported by the support arm plate of the at least one support bracket assembly.

18. A method of installing a series of interlocking ceramic elements to an inside wall of a metallic cylindrical unit comprising:
prefabricating a plurality of support bracket assemblies, wherein each support bracket assembly comprises: two end plates,
a support arm plate located in between the two end plates in a horizontal direction comprising three sections, wherein the three sections are two top sections and one bottom section, wherein a first of the two top sections extends longer than the two end plates in a radial direction and is capable of supporting a ceramic element, and
two horizontal flat bars extending through the two end plates in the horizontal direction, wherein a first horizontal flat bar is located below the first top section of the support arm, and wherein a second horizontal flat bar is located in between a second top section of the support arm and above the bottom section of the support arm plate;
welding the end plates of each support bracket assembly to the inside wall of the metallic cylindrical unit;
placing a ceramic element on each support arm plate of each support bracket assembly;
interconnecting a first row of interlocking ceramic elements, wherein a plurality of elements of the first row of interlocking elements is supported by a support bracket assembly;
welding the support arm plate of each support bracket assembly to the horizontal flat bars of each support bracket assembly once the first row of elements is in place;
interconnecting a second row of interlocking ceramic elements, wherein the second row of elements is supported by the first row of elements; and
interconnecting a plurality of rows of interlocking ceramic elements, wherein each row of elements is supported by a preceding row of elements.
